(19) United States
(12) Patent Application Publication
(10) Pub. No.: US 2020/0106628 A1
(43) Pub. Date: Apr. 2, 2020

(54) BIT FORWARDING ROUTER IDENTIFIER SIGNALING USING PROTOCOL INDEPENDENT MULTICAST ATTRIBUTE

(71) Applicant: Cisco Technology, Inc., San Jose, CA (US)

(72) Inventors: Nagendra Kumar Nainar, Morrisville, NC (US); Ijsbrand Wijnands, Leuven (BE); Carlos M. Pignataro, Cary, NC (US); Rajiv Asati, Morrisville, NC (US)

(21) Appl. No.: 16/149,487

(22) Filed: Oct. 2, 2018

(51) Int. Cl. H04L 12/18; H04L 12/761; H04L 12/741

(52) U.S. Cl. CPC H04L 12/18; H04L 2212/00; H04L 45/745; H04L 45/16

(57) ABSTRACT

In one example embodiment, a bit forwarding egress router of a first area of a multi-area bit index explicit replication (BIER) domain obtains a protocol independent multicast (PIM) join or prune request from a network node in a PIM domain. The bit forwarding egress router inserts, into the PIM join or prune request, a PIM join or prune attribute identifying a bit forwarding router identifier of the bit forwarding egress router. The bit forwarding egress router computes a path to an area border router of the first area of the multi-area BIER domain, and provides the PIM join or prune request via the path to the area border router of the first area of the multi-area BIER domain. Embodiments are also provided with respect to operations performed at an area border router and a bit forwarding ingress router of a multi-area BIER domain.

### TECHNICAL FIELD

The present disclosure relates to multicast technology.

### BACKGROUND

Traditional Internet Protocol (IP) multicast is a bandwidth-conserving technology that reduces network traffic by simultaneously delivering a single stream of information to potentially thousands of recipients. Applications of multicast technology include video conferencing, corporate communications, distance learning, distribution of software, stock quotes, and news. Multicast packets are replicated in a multicast fabric at the point where paths diverge by network nodes enabled with protocols that support multicast (e.g., Protocol Independent Multicast (PIM)), resulting in the efficient delivery of data to multiple receivers.

Bit Indexed Explicit Replication (BIER) is an architecture used to forward multicast flows through an IP network. BIER requires no explicit multicast signaling protocol in the network. Thus, there is no need to run Protocol Independent Multicast (PIM), multipoint LDP (mLDP), or Point-to-Multipoint (P2MP) Multi-Protocol Label Switching (MPLS) traffic engineering within the network to signal multicast state hop-by-hop. Instead, the multicast forwarding state created in the network is driven by advertisements through the link state protocols Open Shortest Path First (OSPF) or Intermediate System-to-Intermediate System (IS-IS). This forwarding state is not per (*,G) or (S,G), but per egress router. As BIER gains traction in the industry, migration strategies for BIER adoption are increasingly desirable.

### BRIEF DESCRIPTION OF THE DRAWINGS

FIG. 1 illustrates a system through which a Protocol Independent Multicast (PIM) join attribute is propagated to signal a Bit Forwarding Router Identifier (BFR-ID), according to an example embodiment.

FIG. 2 illustrates the system of FIG. 1 after the PIM join attribute has been propagated, according to an example embodiment.

FIG. 3 illustrates a router configured to perform BFR-ID signaling using a PIM join attribute, according to an example embodiment.

FIG. 4 illustrates a flowchart of a method for a bit forwarding egress router to perform BFR-ID signaling using a PIM join attribute, according to an example embodiment.

FIG. 5 illustrates a flowchart of a method for an area border router to perform BFR-ID signaling using a PIM join attribute, according to an example embodiment.

FIG. 6 illustrates a flowchart of a method for a bit forwarding ingress router to perform BFR-ID signaling using a PIM join attribute, according to an example embodiment.

### DESCRIPTION OF EXAMPLE EMBODIMENTS

### Overview

In one example embodiment, a bit forwarding egress router of a first area of a multi-area bit index explicit replication (BIER) domain obtains a protocol independent multicast (PIM) join or prune request from a network node in a PIM domain. The bit forwarding egress router inserts, into the PIM join or prune request, a PIM join or prune attribute identifying a bit forwarding router identifier of the bit forwarding egress router. The bit forwarding egress router computes a path to an area border router of the first area of the multi-area BIER domain, and provides the PIM join or prune request via the path to the area border router of the first area of the multi-area BIER domain.

In another example embodiment, an area border router of a first area of a multi-area BIER domain obtains, from a bit forwarding egress router that obtained a PIM join or prune request from a network node in a PIM domain or from an area border router of a second area of the multi-area BIER domain, the PIM join or prune request including a PIM join or prune attribute identifying a bit forwarding router identifier of the bit forwarding egress router. The area border router computes a path to an area border router of a third area of the multi-area BIER domain or to a bit forwarding ingress router of the first area of the multi-area BIER domain. The area border router provides the PIM join or prune request to the area border router of the third area of the multi-area BIER domain or to the bit forwarding ingress router.

In yet another example embodiment, a bit forwarding ingress router of a first area of a multi-area BIER domain obtains a PIM join or prune request from an area border router of a second area of the multi-area BIER domain. The PIM join or prune request includes a PIM join or prune attribute identifying a bit forwarding router identifier of a bit forwarding egress router that obtained the PIM join or prune request from a first network node in a first PIM domain. The bit forwarding ingress router computes a path to a second network node in a second PIM domain, and provides the PIM join or prune request to the second network node.

### Example Embodiments

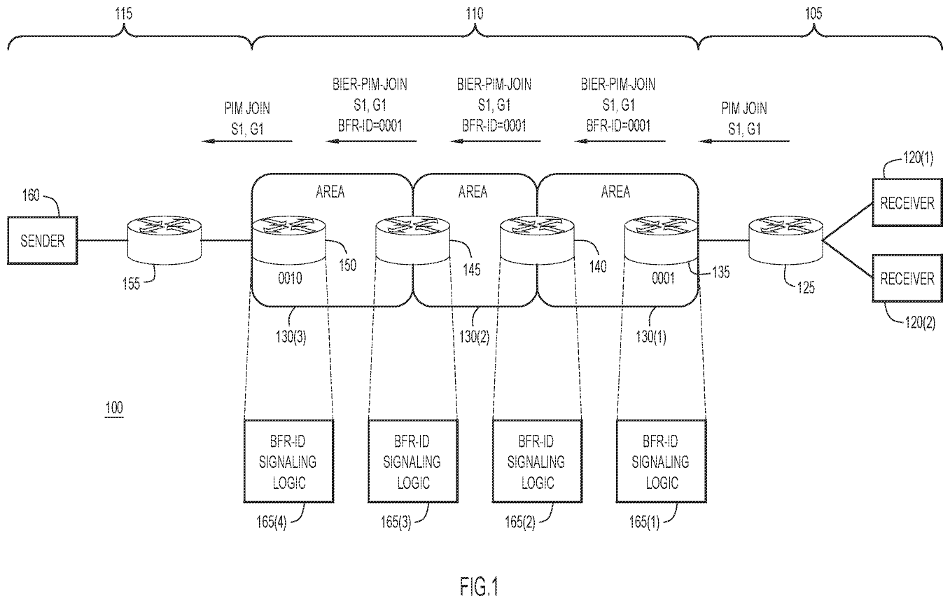

FIG. 1 illustrates an example system 100 through which a Protocol Independent Multicast (PIM) join attribute is propagated to signal a Bit Forwarding Router Identifier (BFR-ID). System 100 includes PIM domain 105, Bit Index Explicit Replication (BIER) domain 110, and PIM domain 115. PIM domain 105 includes receiver (destination) devices 120(1) and 120(2), and network node 125. Receiver devices 120(1) and 120(2) may be any suitable device configured to receive a multicast stream (e.g., server, display, speaker, mobile user device, etc.). Network node 125 may be a switch, router, gateway, etc.

BIER domain 110 includes areas 130(1)-130(3), and further includes bit forwarding egress router 135, area border router 140, area border router 145, and bit forwarding ingress router 150. Area 130(1) includes bit forwarding egress router 135, which has a BFR-ID of 0001, for example. Area 130(3) includes bit forwarding ingress router 150, which has a BFR-ID of 0010, for example. Area border router 140 borders areas 130(1) and 130(2), and may therefore be referred to as an area border router of area 130(1) and/or of area 130(2). Area border router 145 borders areas 130(2) and 130(3), and may therefore be referred to as an area border router of area 130(2) and/or of area 130(3). It will be appreciated that areas 130(1)-130(3) may be different Interior Gateway Protocol (IGP) domains.

PIM domain 115 includes network node 155 and sender (source) device 160. Network node 155 may be a switch, router, gateway, etc. Sender 160 may be any suitable source device of a multicast flow (e.g., server, video camera, microphone, etc.). It will be appreciated that the techniques described herein are not necessarily limited to the exact configuration of system 100. For example, other embodiments may involve any suitable number of receivers, network nodes, senders, and/or areas.

Sender 160 is configured to provide a multicast flow to receivers 120(1) and 120(2). Briefly, receivers 120(1) and 120(2) may send a PIM join request to sender 160. In response, sender 160 may provide the multicast flow to receivers 120(1) and 120(2). Network node 125, for example, may duplicate the multicast flow received from the sender 160 and forward one copy of the multicast flow to each of receivers 120(1) and 120(2). Receivers 120(1) and 120(2) belong to the same multicast group because they obtain identical multicast flows from sender 160.

In one example, system 100 may be the result of a BIER migration. That is, a different architecture may have originally connected PIM domains 105 and 115 before the architecture was migrated to BIER domain 110. As a result of this migration, BIER domain 110 is the core network of system 100 and PIM domains 105 and 115 are the access networks of system 100.

In conventional arrangements, it is assumed that the entire BIER domain includes only a single IGP area. Thus, conventionally, it is assumed that the bit forwarding egress router has a full topology view of the entire BIER domain and can compute a path across the BIER domain to the bit forwarding ingress router upon receiving a PIM join request. The bit forwarding egress router would tunnel the PIM join request over a BIER packet with the bit string in the header of the BIER packet set to the BFR-ID of the bit forwarding ingress router, and the bit forwarding ingress router would then send the PIM join request to the sender.

However, in many real-world use cases the BIER domain includes more than one area. When the BIER domain includes multiple areas, the bit forwarding egress router cannot compute the path across the entire BIER domain to the bit forwarding ingress router. This is because the bit forwarding egress router only has a topology view of the area to which it belongs. As such, the bit forwarding egress router is limited to computing the path to the area border router of the area to which the bit forwarding egress router belongs. Thus, the bit forwarding egress router may resolve the area border router as the IGP next hop to reach the bit forwarding ingress router.

Once the bit forwarding egress router has computed the path to the area border router, the bit forwarding egress router sends the PIM join request to the area border router. The area border router creates a state entry indicating that any received packet belonging to the multicast flow associated with the PIM join request should be forwarded to the bit forwarding egress router. The area border router sends the PIM join request to the bit forwarding ingress router (in the case of a BIER domain with two areas). The area border router may send its BFR-ID with the PIM join request. The area border router is identified by its BFR-ID, which is unique across areas. Upon receiving the PIM join request, the bit forwarding ingress router provides the PIM join request to the sender.

Subsequently, when the sender provides a multicast packet to the bit forwarding ingress router, the bit forwarding ingress router sends the multicast packet to the area border router. Upon receiving the multicast packet, the area border router decapsulates the multicast packet and determines, based on its local state entry, that it should send the multicast packet to the bit forwarding egress router. Accordingly, the area border router re-encapsulates the multicast packet with the BFR-ID of the bit forwarding egress router and sends the multicast packet to the bit forwarding egress router. The bit forwarding egress router then provides the multicast packet to the receiver.

There are at least two technical problems with conventional approaches for providing multicast flows in a multi-area BIER domain. First, area border routers require unique BFR-IDs to allow for signaling PIM join requests and multicast packets. This may become problematic in BIER domains that use a large number of unique BFR-IDs because there may not be enough unique BFR-IDs to assign to every area border router in this case. Second, area border routers must create state entries that indicate where a BIER packet should be forwarded. These state entries present a burden on the memory and processing units of the area border routers.

Accordingly, in order to address these technical problems, BFR-ID signaling logic 165(1)-165(4) is provided in bit forwarding egress router 135, area border router 140, area border router 145, and bit forwarding ingress router 150, respectively. Briefly, BFR-ID signaling logic 165(1)-165(4) obviates the need for area border routers 140 and 145 to have unique assigned BFR-IDs or state entries. In one example, BFR-ID signaling logic 165(1)-165(4) causes bit forwarding egress router 135 to insert a PIM join attribute in the PIM join request identifying a BFR-ID of the bit forwarding egress router 135. The PIM join request thus enables the area border router 140, area border router 145, and bit forwarding ingress router 150 to send subsequent multicast packets using only a single BFR-ID, namely the BFR-ID of bit forwarding egress router 135. It will be appreciated that although the examples provided herein are discussed with reference to a PIM join request, a PIM prune request (whereby a receiver requests to leave a multicast group) may be utilized in a similar manner to signal the BFR-ID of a bit forwarding egress router.

BFR-ID signaling logic 165(1)-165(4) may vary depending on the particular device upon which BFR-ID signaling logic 165(1)-165(4) is implemented. For example, BFR-ID signaling logic 165(1) may include operations specific to bit forwarding egress router 135, and BFR-ID signaling logic 165(4) may include operations specific to bit forwarding ingress router 150. Furthermore, BFR-ID signaling logic 165(2) and 165(3) may include operations specific to area border routers 140 and 145. Alternatively, BFR-ID signaling logic 165(1)-165(4) may each include identical/similar operations regardless of the particular device upon which BFR-ID signaling logic 165(1)-165(4) is implemented.

In the example of system 100, receiver 120(1) may send a PIM join request to sender 160. The PIM join request identifies multicast source Si (e.g., sender 160) and multicast group G1 (e.g., a multicast stream to which receiver 120(1) is requesting to subscribe). Network node 125 receives the PIM join request and sends the PIM join request to bit forwarding egress router 135. Bit forwarding egress router 135 obtains the PIM join request from network node 125 and inserts, into the PIM join request, a PIM join attribute identifying the BFR-ID of bit forwarding egress router 135 (i.e., 0001). A PIM join attribute is metadata carried in a PIM join request.

The bit forwarding egress router 135 may insert an entry into a local BIER table. The entry in the BIER table may include the BFR-ID of the bit forwarding egress router 135 (here, 0001) and an indication to decapsulate a multicast packet from a BIER header sent in response to the PIM join request. The bit forwarding egress router 135 may also insert an entry into a local forwarding table. The entry in the forwarding table may identify multicast source Si and multicast group G1, and network node 125.

Bit forwarding egress router 135 may compute a path to area border router 140, and send the PIM join request via the path to area border router 140. In one example, to avoid the need for assigning a BFR-ID to the area border routers, the PIM join request may be a unicast packet (e.g., an IP unicast packet). The PIM join request may include an identification of bit forwarding ingress router 150 as an upstream neighbor.

Area border router 140 may obtain the PIM join request from bit forwarding egress router 135 and compute a path to area border router 145. In one example, area border router 140 may perform a lookup to identify the upstream neighbor (here, bit forwarding ingress router 150) and compute the path based on the identification of bit forwarding ingress router 150 as the upstream neighbor. Area border router 140 may send the PIM join request to area border router 145 without creating a local state entry (following the control plane semantic for a BIER PIM join request). Area border router 140 may, however, insert an entry into a local BIER table that enables the BIER architecture. The entry may include an indication to provide a multicast packet sent in response to the PIM join request to bit forwarding egress router 135. In one example, to avoid the need for assigning a BFR-ID to the area border routers, the PIM join request may be a unicast packet (e.g., an IP unicast packet).

Area border router 145 may obtain the PIM join request from area border router 140 and compute a path to bit forwarding ingress router 150. In one example, area border router 145 may perform a lookup to identify the upstream neighbor (here, bit forwarding ingress router 150) and compute the path based on the identification of bit forwarding ingress router 150 as the upstream neighbor. Area border router 145 may send the PIM join request to bit forwarding ingress router 150 without creating a local state entry. Area border router 145 may, however, insert an entry into a local BIER table that enables the BIER architecture. The entry may include an indication to provide a multicast packet sent in response to the PIM join request to area border router 140. In one example, to avoid the need for assigning a BFR-ID to the area border routers, the PIM join request may be a unicast packet (e.g., an IP unicast packet).

Bit forwarding ingress router 150 may obtain the PIM join request from area border router 145. Bit forwarding ingress router 150 may also insert an entry into a local forwarding table. The entry in the forwarding table may identify the multicast source Si and the multicast group G1, and the BFR-ID of the bit forwarding egress router 135. Bit forwarding ingress router 150 may additionally compute a path to network node 155 and send the PIM join request to network node 155. Network node 155 may send the PIM join request to sender 160 so as to add receiver 120(1) to the multicast group G1.

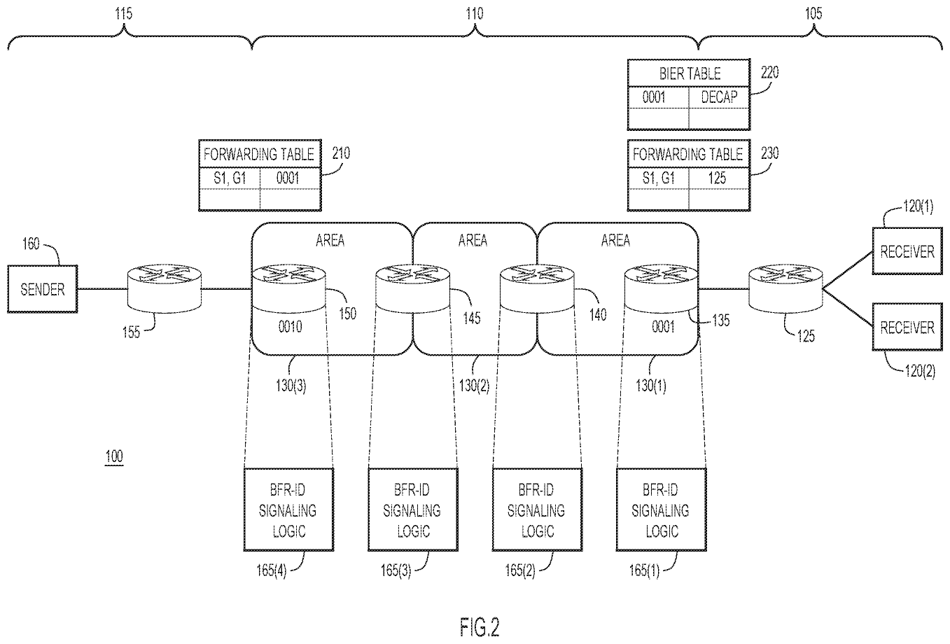

FIG. 2 illustrates an example of system 100 at some later point in time than that shown in FIG. 1. In the example of FIG. 2, sender 160 provides a multicast packet in response to the PIM join request. The network node 155 may receive the multicast packet and send the multicast packet to bit forwarding ingress router 150. Bit forwarding ingress router 150 obtains the multicast packet and provides the multicast packet to area border router 145. In one example, bit forwarding ingress router 150 determines that the multicast packet originated from the multicast source Si and belongs to the multicast group G1 and, in response, encapsulates the multicast packet in a BIER header including the BFR-ID of bit forwarding egress router 135. Bit forwarding ingress router 150 may encapsulate the multicast packet based on the entry in the local forwarding table 210 of bit forwarding egress router 135.

Area border router 145 may obtain the multicast packet and provide the multicast packet to area border router 140. Area border router 140 may, in turn, obtain the multicast packet and provide the multicast packet to bit forwarding egress router 135. Area border routers 140 and 145 may simply forward the multicast packet according to their respective local BIER tables. This is in contrast to conventional approaches in which area border routers would decapsulate the multicast packet, check the local state entry, and then re-encapsulate the multicast packet based on the local state entry. Unlike these conventional approaches, area border routers 140 and 145 do not need unique BFR-IDs or local state entries.

Bit forwarding egress router 135 may obtain the multicast packet and provide the multicast packet to network node 125. Bit forwarding egress router 135 may decapsulate the multicast packet from the BIER header based on the entry in local BIER table 220. Bit forwarding egress router 135 may further determine that the multicast packet originated from the multicast source Si and belongs to the multicast group G1 and, in response, provide the multicast packet to network node 125. In one example, bit forwarding egress router 135 may provide the multicast packet to network node 125 based on the entry in local forwarding table 230. Upon receiving the multicast packet, network node 125 may duplicate the multicast packet and send one copy each to receivers 120(1) and 120(2).

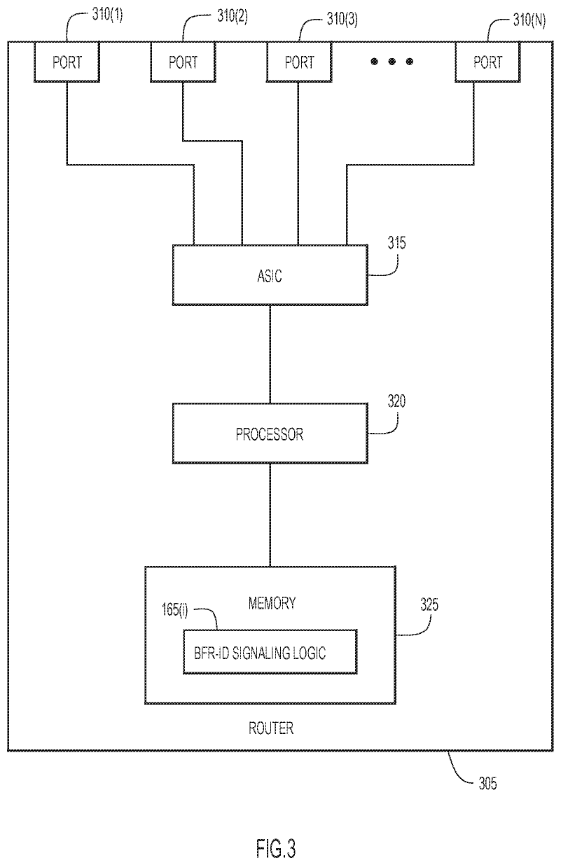

FIG. 3 is a block diagram of a router 305 (e.g., bit forwarding egress router 135, area border router 140, area border router 145, or bit forwarding ingress router 150) that is configured to implement techniques presented herein. Router 305 includes a network interface in the form of a plurality of network ports 310(1)-310(N) that enable communications over a network, one or more Application Specific Integrated Circuits (ASICs) 315 or line cards that perform(s) network processing functions, one or more processors 320 (e.g., microprocessors or microcontrollers), and a memory 325. The memory 325 includes BFR-ID signaling logic 165(i) (e.g., BFR-ID signaling logic 165(1)-165(4)).

The memory 325 may include read only memory (ROM), random access memory (RAM), magnetic disk storage media devices, optical storage media devices, flash memory devices, electrical, optical, or other physical/tangible memory storage devices. Thus, in general, the memory 325 may comprise one or more tangible (non-transitory) computer readable storage media (e.g., a memory device) encoded with software comprising computer executable instructions and when the software is executed (e.g., by the one or more processors 320) it is operable to perform operations described herein. In particular, as noted, memory 325 includes BFR-ID signaling logic 165(i) that, when executed, enables the router 305 to perform operations described herein.

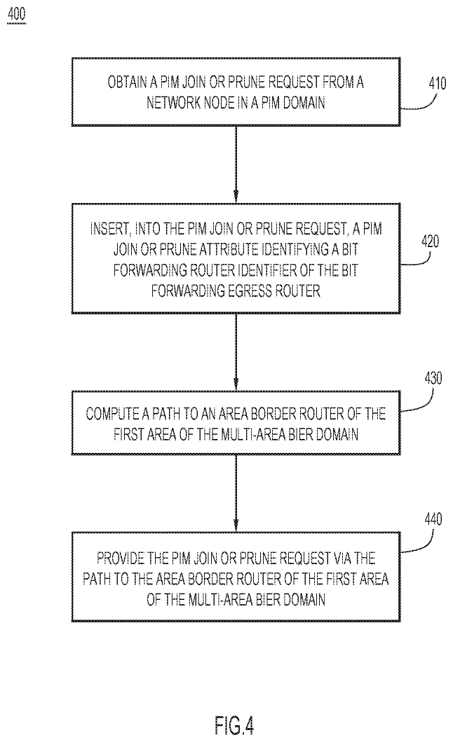

FIG. 4 is a flowchart of a method 400 by which a bit forwarding egress router performs BFR-ID signaling using a PIM join or prune attribute. Method 400 may be performed at a bit forwarding egress router of a first area of a multi-area BIER domain. At 410, the bit forwarding egress router obtains a PIM join or prune request from a network node in a PIM domain. At 420, the bit forwarding egress router inserts, into the PIM join or prune request, a PIM join or prune attribute identifying a bit forwarding router identifier of the bit forwarding egress router. At 430, the bit forwarding egress router computes a path to an area border router of the first area of the multi-area BIER domain. At 440, the bit forwarding egress router provides the PIM join or prune request via the path to the area border router of the first area of the multi-area BIER domain.

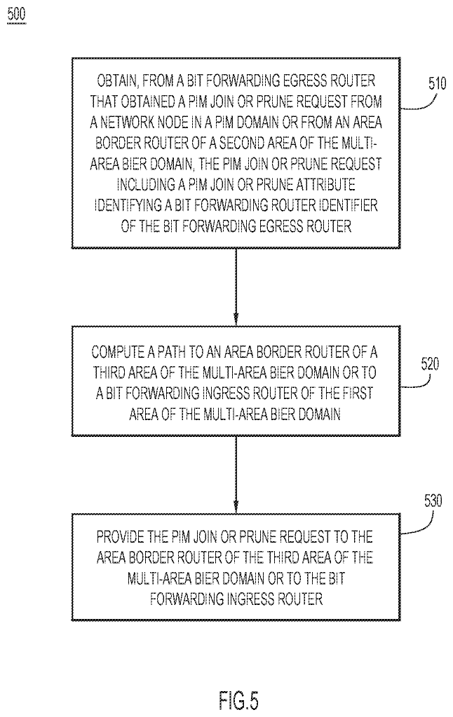

FIG. 5 is a flowchart of a method 500 by which an area border router performs BFR-ID signaling using a PIM join or prune attribute. Method 500 may be performed at an area border router of a first area of a multi-area BIER domain. At 510, the area border router obtains, from a bit forwarding egress router that obtained a PIM join or prune request from a network node in a PIM domain or from an area border router of a second area of the multi-area BIER domain, a PIM join or prune request including a PIM join or prune attribute identifying a bit forwarding router identifier of the bit forwarding egress router. At 520, the area border router computes a path to an area border router of a third area of the multi-area BIER domain or to a bit forwarding ingress router of the first area of the multi-area BIER domain. At 530, the area border router provides the PIM join or prune request to the area border router of the third area of the multi-area BIER domain or to the bit forwarding ingress router.

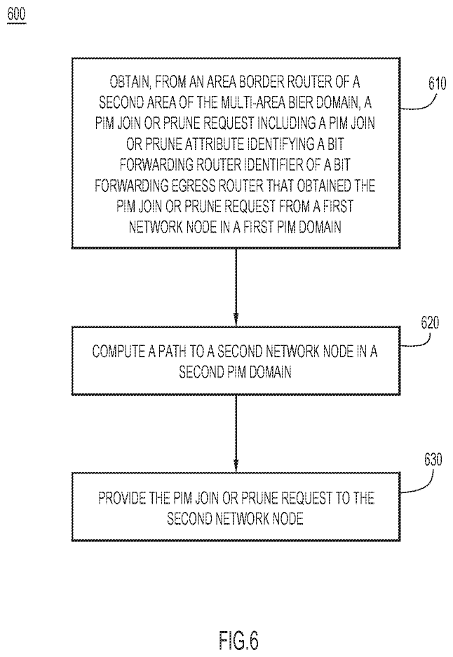

FIG. 6 is a flowchart of a method 600 by which a bit forwarding ingress router performs BFR-ID signaling using a PIM join or prune attribute. Method 600 may be performed at a bit forwarding ingress router of a first area of a multi-area BIER domain. At 610, the bit forwarding ingress router obtains, from an area border router of a second area of the multi-area BIER domain, a PIM join or prune request including a PIM join or prune attribute identifying a bit forwarding router identifier of a bit forwarding egress router that obtained the PIM join or prune request from a first network node in a first PIM domain. At 620, the bit forwarding ingress router computes a path to a second network node in a second PIM domain. At 630, the bit forwarding ingress router provides the PIM join or prune request to the second network node.

Techniques described herein eliminate the needs for unique BFR-ID assignments for area border routers and for state entry creation on area border routers. This may be particularly helpful where address summarization is performed at area boundaries, thereby preventing the direct identification of the bit forwarding ingress router via PIM. These techniques may enable the incremental deployment/migration of BIER architecture in any network (e.g., single or multi-area) without the need for static routes or the Border Gateway Protocol (BGP).

When a bit forwarding egress router computes a path and identifies that a source is reachable via a remote area, the bit forwarding egress router may forward the PIM join request to the area border router. In doing so, the bit forwarding egress router may set the source as the BFR prefix of the bit forwarding egress router. But when the area border router (re)forwards the PIM join request to a remote area border router or the bit forwarding ingress router, the area border router sets the source address as its own address. For this reason, the bit forwarding ingress router may not be able to determine the BFR-ID of the bit forwarding egress router from the source address of the PIM join request. Accordingly, carrying the BFR-ID of the bit forwarding egress router in the PIM join attribute may be preferable.

Upon receiving a PIM join request, the bit forwarding egress router may encapsulate the PIM join request in a BIER header and unicast the encapsulated PIM join request to an IGP next hop (e.g., area border router or bit forwarding ingress router). The PIM join request may include PIM join attributes carrying the BFR-ID of the bit forwarding egress router. For example, the bit forwarding egress router may insert the BFR-ID of the bit forwarding egress router as the PIM join attribute. When an area border router in the BIER domain receives the PIM join request, the area border router may simply perform a lookup for the source in the PIM join request and forward the PIM join request further towards the IGP next hop, without creating a local state entry. When the bit forwarding ingress router receives the PIM join request, the bit forwarding ingress router may create a local state entry with the BFR-ID of the bit forwarding egress router included in the bit string.

These techniques have a wide scope of applicability, and may be implemented in single-area, multi-area, and/or multi-domain scenarios. Additionally, avoiding the assignment of unique bit positions to area border routers is bit budget friendly. Moreover, preventing area border routers from creating state entries helps the system to retain its stateless nature.

In one form, a method is provided. The method comprises: at a bit forwarding egress router of a first area of a multi-area BIER domain: obtaining a PIM join or prune request from a network node in a PIM domain; inserting, into the PIM join or prune request, a PIM join or prune attribute identifying a bit forwarding router identifier of the bit forwarding egress router; computing a path to an area border router of the first area of the multi-area BIER domain; and providing the PIM join or prune request via the path to the area border router of the first area of the multi-area BIER domain.

In another form, a bit forwarding egress router of a first area of a multi-area BIER domain is provided. The bit forwarding egress router comprises: a network interface configured to send and/or receive messages; and a processor in communication with the network interface, wherein the processor is configured to: obtain a PIM join or prune request from a network node in a PIM domain; insert, into the PIM join or prune request, a PIM join or prune attribute identifying a bit forwarding router identifier of the bit forwarding egress router; compute a path to an area border router of the first area of the multi-area BIER domain; and provide the PIM join or prune request via the path to the area border router of the first area of the multi-area BIER domain.

In another form, one or more non-transitory computer readable storage media are provided. The non-transitory computer readable storage media are encoded with instructions that, when executed by a processor of a bit forwarding egress router of a first area of a multi-area BIER domain, cause the processor to: obtain a PIM join or prune request from a network node in a PIM domain; insert, into the PIM join or prune request, a PIM join or prune attribute identifying a bit forwarding router identifier of the bit forwarding egress router; compute a path to an area border router of the first area of the multi-area BIER domain; and provide the PIM join or prune request via the path to the area border router of the first area of the multi-area BIER domain.

In one form, a method is provided. The method comprises: at an area border router of a first area of a multi-area BIER domain: obtaining, from a bit forwarding egress router that obtained a PIM join or prune request from a network node in a PIM domain or from an area border router of a second area of the multi-area BIER domain, the PIM join or prune request including a PIM join or prune attribute identifying a bit forwarding router identifier of the bit forwarding egress router; computing a path to an area border router of a third area of the multi-area BIER domain or to a bit forwarding ingress router of the first area of the multi-area BIER domain; and providing the PIM join or prune request to the area border router of the third area of the multi-area BIER domain or to the bit forwarding ingress router.

In another form, an area border router of a first area of a multi-area BIER domain is provided. The area border router comprises: a network interface configured to send and/or receive messages; and a processor in communication with the network interface, wherein the processor is configured to: obtain, from a bit forwarding egress router that obtained a PIM join or prune request from a network node in a PIM domain or from an area border router of a second area of the multi-area BIER domain, the PIM join or prune request including a PIM join or prune attribute identifying a bit forwarding router identifier of the bit forwarding egress router; compute a path to an area border router of a third area of the multi-area BIER domain or to a bit forwarding ingress router of the first area of the multi-area BIER domain; and provide the PIM join or prune request to the area border router of the third area of the multi-area BIER domain or to the bit forwarding ingress router.

In another form, one or more non-transitory computer readable storage media are provided. The non-transitory computer readable storage media are encoded with instructions that, when executed by a processor of an area border router of a first area of a multi-area BIER domain, cause the processor to: obtain, from a bit forwarding egress router that obtained a PIM join or prune request from a network node in a PIM domain or from an area border router of a second area of the multi-area BIER domain, the PIM join or prune request including a PIM join or prune attribute identifying a bit forwarding router identifier of the bit forwarding egress router; compute a path to an area border router of a third area of the multi-area BIER domain or to a bit forwarding ingress router of the first area of the multi-area BIER domain; and provide the PIM join or prune request to the area border router of the third area of the multi-area BIER domain or to the bit forwarding ingress router.

In one form, a method is provided. The method comprises: at a bit forwarding ingress router of a first area of a multi-area BIER domain: obtaining, from an area border router of a second area of the multi-area BIER domain, a PIM join or prune request including a PIM join or prune attribute identifying a bit forwarding router identifier of a bit forwarding egress router that obtained the PIM join or prune request from a first network node in a first PIM domain; computing a path to a second network node in a second PIM domain; and providing the PIM join or prune request to the second network node.

In another form, a bit forwarding ingress router of a first area of a multi-area BIER domain is provided. The bit forwarding ingress router comprises: a network interface configured to send and/or receive messages; and a processor in communication with the network interface, wherein the processor is configured to: obtain, from an area border router of a second area of the multi-area BIER domain, a PIM join or prune request including a PIM join or prune attribute identifying a bit forwarding router identifier of a bit forwarding egress router that obtained the PIM join or prune request from a first network node in a first PIM domain; compute a path to a second network node in a second PIM domain; and provide the PIM join or prune request to the second network node.

In another form, one or more non-transitory computer readable storage media are provided. The non-transitory computer readable storage media are encoded with instructions that, when executed by a processor of a bit forwarding ingress router of a first area of a multi-area BIER domain, cause the processor to: obtain, from an area border router of a second area of the multi-area BIER domain, a PIM join or prune request including a PIM join or prune attribute identifying a bit forwarding router identifier of a bit forwarding egress router that obtained the PIM join or prune request from a first network node in a first PIM domain; compute a path to a second network node in a second PIM domain; and provide the PIM join or prune request to the second network node.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
at a bit forwarding egress router of a first area of a multi-area bit index explicit replication (BIER) domain:
obtaining a protocol independent multicast (PIM) join or prune request from a network node in a PIM domain;
inserting, into the PIM join or prune request, a PIM join or prune attribute identifying a bit forwarding router identifier of the bit forwarding egress router;
computing a path to an area border router of the first area of the multi-area BIER domain; and
providing the PIM join or prune request via the path to the area border router of the first area of the multi-area BIER domain.

2. The method of claim 1, further comprising:
at the bit forwarding egress router:
obtaining, from the area border router, a multicast packet encapsulated in a BIER header including the bit forwarding router identifier of the bit forwarding egress router, wherein the multicast packet is in response to the PIM join or prune request; and
providing the multicast packet to the network node in the PIM domain.

3. The method of claim 2, further comprising:
at the bit forwarding egress router:
inserting an entry into a local BIER table, wherein the entry includes the bit forwarding router identifier of the bit forwarding egress router and an indication to decapsulate the multicast packet from the BIER header; and
decapsulating the multicast packet from the BIER header.

4. The method of claim 2, further comprising:
at the bit forwarding egress router:
inserting an entry into a local forwarding table, wherein the entry identifies a multicast source and a multicast group, and the network node in the PIM domain;
determining that the multicast packet originated from the multicast source and belongs to the multicast group; and
in response to determining that the multicast packet originated from the multicast source and belongs to the multicast group, providing the multicast packet to the network node in the PIM domain.

5. The method of claim 1, wherein the PIM join or prune attribute further includes an identification of a bit forwarding ingress router of a second area of the multi-area BIER domain.

6. The method of claim 1, wherein the PIM join or prune request is a unicast frame.

7. A method comprising:
at an area border router of a first area of a multi-area bit index explicit replication (BIER) domain:
obtaining, from a bit forwarding egress router that obtained a protocol independent multicast (PIM) join or prune request from a network node in a PIM domain or from an area border router of a second area of the multi-area BIER domain, the PIM join or prune request including a PIM join or prune attribute identifying a bit forwarding router identifier of the bit forwarding egress router;
computing a path to an area border router of a third area of the multi-area BIER domain or to a bit forwarding ingress router of the first area of the multi-area BIER domain; and
providing the PIM join or prune request to the area border router of the third area of the multi-area BIER domain or to the bit forwarding ingress router.

8. The method of claim 7, further comprising:
at the area border router of the first area of the multi-area BIER domain:
obtaining, from the area border router of the third area of the multi-area BIER domain or from the bit forwarding ingress router, a multicast packet encapsulated in a BIER header including the bit forwarding router identifier of the bit forwarding egress router, wherein the multicast packet is in response to the PIM join or prune request; and
providing the multicast packet to the bit forwarding egress router or to the area border router of the second area of the multi-area BIER domain.

9. The method of claim 8, further comprising:
at the area border router of the first area of the multi-area BIER domain:
inserting an entry into a local BIER table, wherein the entry includes an indication to provide the multicast packet to the bit forwarding egress router or to the area border router of the second area of the multi-area BIER domain.

10. The method of claim 7, wherein the PIM join or prune attribute further includes an identification of the bit forwarding ingress router, and wherein:
computing the path includes computing the path based on the identification of the bit forwarding ingress router.

11. The method of claim 7, wherein:
computing the path includes computing the path to the area border router of the third area of the multi-area BIER domain; and
providing the PIM join or prune request includes providing the PIM join or prune request to the area border router of the third area of the multi-area BIER domain.

12. The method of claim 7, wherein:
computing the path includes computing the path to the bit forwarding ingress router; and
providing the PIM join or prune request includes providing the PIM join or prune request to the bit forwarding ingress router.

13. The method of claim 7, wherein:
obtaining the PIM join or prune request includes obtaining the PIM join or prune request from the bit forwarding egress router.

14. The method of claim 7, wherein:
obtaining the PIM join or prune request includes obtaining the PIM join or prune request from the area border router of the second area of the multi-area BIER domain.

15. The method of claim 7, wherein the PIM join or prune request is a unicast frame.

16. A method comprising:
at a bit forwarding ingress router of a first area of a multi-area bit index explicit replication (BIER) domain:
obtaining, from an area border router of a second area of the multi-area BIER domain, a protocol independent multicast (PIM) join or prune request including a PIM join or prune attribute identifying a bit forwarding router identifier of a bit forwarding egress router that obtained the PIM join or prune request from a first network node in a first PIM domain;
computing a path to a second network node in a second PIM domain; and
providing the PIM join or prune request to the second network node.

17. The method of claim 16, further comprising:
at the bit forwarding ingress router:
obtaining, from the second network node, a multicast packet in response to the PIM join or prune request; and
providing the multicast packet to the area border router.

18. The method of claim 17, further comprising:
at the bit forwarding ingress router:
inserting an entry into a local forwarding table, wherein the entry identifies a multicast source and a multicast group, and the bit forwarding router identifier of the bit forwarding egress router;
determining that the multicast packet originated from the multicast source and belongs to the multicast group; and
encapsulating the multicast packet in a BIER header including the bit forwarding router identifier of the bit forwarding egress router to produce an encapsulated multicast packet, wherein:
providing the multicast packet to the area border router includes providing the encapsulated multicast packet to the area border router.

19. The method of claim 16, wherein the PIM join or prune attribute further includes an identification of the bit forwarding ingress router.

20. The method of claim 16, wherein the PIM join or prune request is a unicast frame.
